(19) United States
(12) Patent Application Publication
(10) Pub. No.: US 2003/0036949 A1
(43) Pub. Date: Feb. 20, 2003

(54) Method and system for targeting internet advertisements and messages by geographic location

(76) Inventors: Karim Kaddeche, Santa Ana, CA (US); John Wang, Orange, CA (US)

Correspondence Address: Philip K. Yu, Registered Patent Attorney, 20955 Pathfinder Road, Ste.160, Diamond Bar, CA, 91765, US

(21) Appl. No.: 09/733,891

(22) Filed: Dec. 9, 2000

Related U.S. Application Data
(60) Provisional application No. 60/170,146, filed on Dec. 10, 1999.

(51) Int. Cl. G06F 17/60

(52) U.S. Cl. 705/14; 701/208; 709/209

(57) ABSTRACT

A method and system of targeting an Internet messaged to an Internet client based on geographic information of the Internet client is disclosed. The present invention first obtains IP addresses of Internet clients as they visit their web sites. The present invention then obtains addresses from the Internet clients and transforming the addresses to latitude/longitude coordinates for each of the Internet clients. A lookup table can thus be generated by correlating the IP addresses with the addresses and latitude/longitude coordinates. The information can be mined to resolve multiple entry conflicts to extract most likely position of a particular address. When an Internet client visits a web server, the IP address is collected from the Internet client to be targeted. The location of the Internet client can then be approximated by comparing the client's IP address with the lookup table. Upon approximation, a commercial message is transmitted to the Internet client, wherein the commercial message is related to the geographical location of the Internet client.

### CROSS REFERENCE TO RELATED APPLICATION

This application claims priority from provisional application Serial No. 60/170,146, filed Dec. 10, 1999, entitled “Method and System for Targeting Internet Advertisements and Messages By Geographic Location.”

### RELATED FIELD

The present invention is related to the global computer information network, commonly called the Internet, and more particularly is related to providing targeted information to Internet based on their geographical location.

### ART BACKGROUND

Advertising on the Internet and the world-wide web (“WWW”) is becoming a viable way for corporations to reach a large audience nationally and internationally. Every day, hundreds of millions of advertising messages in the form of images, texts or combination thereof, are placed within Web pages to be viewed by Internet users, or clients. A fraction of these viewers, being enticed by the advertising images, will choose to click on the advertisement with their pointing devices. In this case, the viewer will be redirected to the advertiser's home page server where the viewer can purchase the advertised product or services, or simply find out more about the products or services.

This method of advertising through the Internet has many advantages over conventional printed media. The first of these advantages is that lead times for Internet ads can be much shorter than those associated with conventional printmedia. Another advantage is the ability to keep track of the number and the quality of the “leads” generated by each advertisement. As a result the total amount of dollars spent by advertisers on Internet banner ads has grown from $940 million dollars in 1997 to $1.9 billion dollars in 1998. The trend is continuing with more people get on-line.

However, Internet advertising remains an attractive avenue only for those corporations seeking nation-wide or international reach. Internet advertising is also limited to those companies doing E-Commerce without having any specific local, or “brick-and-mortar,” presence. For example, companies like E*Trade or Amazon.com take advantage of Internet advertising without having to attract real walk-in customers through any physical offices. On the other hand, a local Ford dealership would want its ads, whether it is Internet ads or printed ads, to be targeted to those who can and are likely to visit the local dealership to “kick the tires.” While Ford Motor Company uses the Internet to gain national and international exposure, a local or regional Ford dealership may find Internet advertising an expensive and inefficient proposition. For many regional or local merchants, advertising through the Internet does not seem to reach the desired demographics.

The inability of Internet advertisers to target their ads or messages to smaller geographic locations means that those regional merchants and vendors are not interested in spending their advertising dollars on Internet banners. The very power of the Internet to reduce geographical barriers and the ease with which a client can view a page over great distances are a major disadvantage for a large portion of advertisers.

In the description throughout this application, the terms “advertisement,” “information” and “message” will be used interchangeably. Advertising is essentially a form of directed message or information to an recipient, intended or unintended.

Of course, if an Internet client gives out personal information directly, then it will be easy for the advertisers to target such Internet client. However, such voluntary input by Internet clients typically occurs in on-line shopping or news transactions, i.e. when the Internet clients desire to receive something from the vendor. When an Internet client randomly, and anonymously, browses a web site, there is no effective way to reach such client.

Therefore, it is desirable to be able to target advertisements more precisely on the Internet.

It is also desirable to be able to target advertisements to the population within a practical geographical region.

It is further desirable to be able to target advertisement on the Internet without having to ask each viewer to reveal his or her individual information.

### SUMMARY OF THE INVENTION

A method and system of targeting an Internet message to an Internet client based on geographic information of the Internet client has disclosed. The present invention first obtains IP addresses of Internet clients as they visit their web sites. The present invention then obtains addresses from the Internet clients and transforming the addresses to latitude/longitude coordinates for each of the Internet clients. A lookup table can thus be generated by correlating the IP addresses with the addresses and latitude/longitude coordinates. The information can be mined to resolve multiple entry conflicts to extract most likely position of a particular address. When an Internet client visits a web server, the IP address is collected from the Internet client to be targeted. The location of the Internet client can then be approximated by comparing the client's IP address with the lookup table. Upon approximation, a commercial message is transmitted to the Internet client, wherein the commercial message is related to the geographical location of the Internet client.

Another aspect of the present invention can be implemented where the opportunity to transmit an advertisement to the Internet client is “auctioned” to the highest bidder from a number of advertising sources on a real-time basis.

### BRIEF DESCRIPTION OF THE DRAWINGS

FIG. 1 is a simplified diagram showing the environment of servers and clients with the Internet.

FIG. 2 is a simplified diagram of one embodiment of the present invention.

### DESCRIPTION OF THE INVENTION

This invention addresses the need of Internet advertisers to target their ads, such as banner ads, by geographic location of the users. The methodology of the present invention collects geographic information on a very large number of Internet users. This data is then accumulated within a database that relates a user's Internet address, or IP address, to his or her geographic coordinates (Latitude and Longitude). A user's geographical coordinates can thus be derived from a mailing address through a process commonly referred to a “geocoding.” It should be appreciated by those skilled in the art of Internet communication that every time a user accesses a web page, his or her IP address is known to the web server.

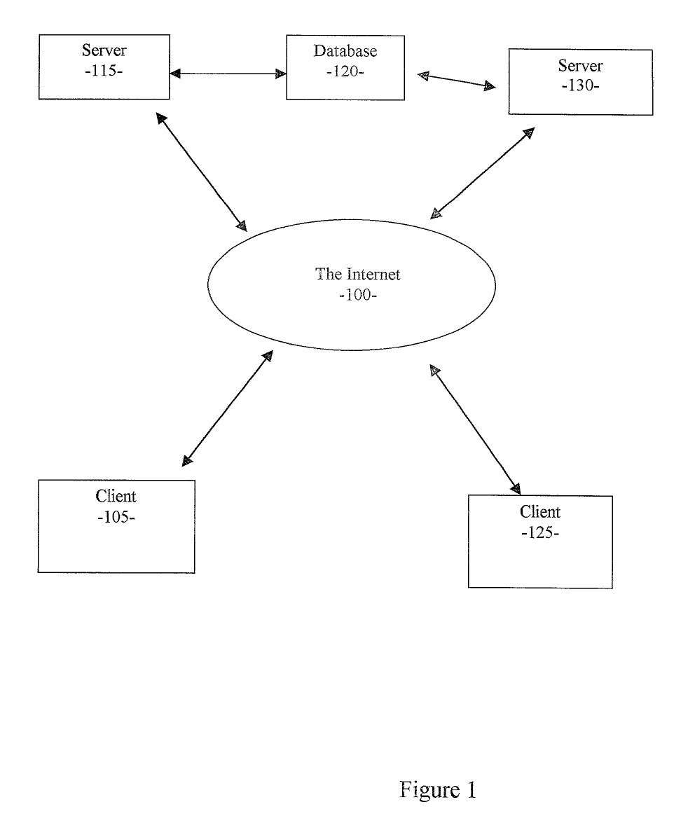

FIG. 1 shows a generic diagram of the servers and clients with the Internet. As an example, client 105 may access server 115 through the Internet 100 and client 125 may access server 130 also through the Internet. Database 120 may be used by server 115 or server 130, or both, to collect and retrieve information. It should be noted that database 120 may be a single database or a collection of databases, which can be operatively linked for storage and retrieval.

Every time a user, say client 105, submits the user's street address, for example when the user completes an on-line registration for free news or mail services, the application server 115 “geocodes” the address and associates the client's IP address with the resulting Latitude/Longitude. Applications that require the user to submit his or her mailing address are quite common in the worldwide web. Just about every e-commerce site requires the user to do that as part of the billing process or information or usage tracking purposes. Further, it should be noted that a user's zip code, instead of actual physical addresses, can also provide the association with the IP address, since zip codes can identify a given region. Zip codes are also less intrusive than addresses, which users may be reluctant to give out voluntarily.

It should be appreciated by those skilled in the art that many attributes requested by server 115 and replied by client 105, such as zip code, telephone area code and prefix, city or street address, can be used to build the location-IP address correlation. For data collection purposes, it does not need the exact address, which most users do not wish to give out, of an Internet user and there are many attributes that can help build the database 120. For the purpose of this application, the term “address” broadly refers to any attribute or attributes that can identify a geographical point, region, area, location and longitude/latitude.

The addresses can also be collected by deploying a large number of geographically oriented web applets that provide local information, such as local news, local weather, maps, TV listings, traffic conditions, and more. Web authors can include these web applets in any web page free of charge or for a low fee, resulting in maximum coverage of Internet surfers.

It is preferable to have millions of web pages embedding the applets, each page generating perhaps hundreds of page views every month. The applets are in themselves a good source of geographically targeted advertising, but they also serve the purpose of collecting geographic information on users.

The systematic collection of users' addresses, zip codes, radius, driving time/distance, or any other geographical or location-sensitive information on the users and correlating these information with the users' IP address can be an application software resident at a server or multiple servers. Any web site that desires to offer geographically targeted ads can interface with this server(s) to request geographic information on each of its clients. Finally the ability to target ads geographically will allow facilitate the process of buying generic ad space on any web site in wholesale and reselling the same ads as geographically targeted.

The following will illustrate a preferred embodiment of the present invention:

1. First the web site needs to attracting users to visit the web site, i.e. generating traffic, which can be implemented at any web server. For example, a web site can offer services such as mapping, news, email, on-line shopping, search engine, or transaction. Also, a large number of geographically-oriented applets can be implemented, the operation of which will provide geographic information on the users. Of course, the server may have to adopt a strict privacy policy to ensure that the users' information will not be released or misused.

2. While the users are browsing the web site, the web site collects the IP addresses of users during their web bir web bir web bir web browsing. As can be unde in the WWW, the collection of IP addresses is done automatically and is a required protocol for any server-client interface on the Internet or WWW.

3. While the users are browsing the web site or using the geographically oriented applets, the web site or the applets can collect geographical information, or the aforementioned “address,” such as physical address, street or zip codes of the users, or the current map extent. Getting the users to reply may be accomplished by simple on-line registration, query or survey. As previously described, such information is already collected by e-commerce merchants, ISP's or provider of free services. And many users of the Internet and e-commerce have accepted this as an exchange for online service or shopping, provided their privacy can be ensured. Also, a cookie may be stored on the client side for future identification of the client.

4. Upon collecting IP addresses and geographical information from many users, the IP addresses are used to associate with the geographical information. If the physical addresses are used, then the latitude/longitude coordinates can be generated by geocoding and used for association with the IP addresses. Collecting may be done by one server, or by a group of servers of different web sites. In fact, many servers or web sites may find that the collaboration generates better correlation between IP addresses and location.

5. A lookup table can be constructed to derive a polygon based on all the physical addresses of the users. When the collection mechanism is widely deployed, the lookup table, or database, can easily acquire and build a massive database relating IP addresses with geographical location. In order to resolve multiple entries for the same IP address, the area polygon representing all possible locations for that IP can be built. With the database, any Internet client's geographical location can be located, by extrapolation, based on the Internet client's IP address. It should be understood by those skilled in the art of Internet Protocol that while no two Internet clients will have the same IP address, the Internet clients' IP addresses will have at least a portion (out of the 32-bit representation) of the IP addresses in common.

When an exact match for an Internet client's IP is not found on the database, the IP address can be matched to another IP address with the maximum number of significant bits in common by matching bits left to right.

6. From the geographic location, it is possible to derive the most likely values for some demographic attributes of an Internet. This is usually done by referring to a census coverage file.

This database can be used by any web site to generate geographically targeted advertisements to the web site's visitors. In other words, when a user in Los Angeles visits a web site based in New York, the web site's server, upon receiving the user's IP address and determining the user's physical address, can display an ad sponsored by a merchant from Los Angeles or someplace even closer to the user's home. As can be appreciated by those skilled in the art, the lookup table allows a local or regional advertisement to be targeted to those Internet users whose IP addresses correspond to physical addresses within the neighborhood of the local advertisement, independent of where the Internet user surfs.

7.m(0.03U7.m(0.03U7. When a user's adsome of the user's demographic information may also be deduced for even more targeted advertising or messaging. For example, if the user's address is within a typically Asian neighborhood, this information can facilitate even more targeted advertisement. For example, if the information collected suggests that the user lives in the downtown of New York City, then advertisement geared toward city dwellers may be targeted to the user. If in Florida, then perhaps advertisement for sun tan protection, or for retirement life style may be targeted. All this improved advertisement targeting can be done without the user ever entering any information about his or her location, since the location is ‘deduced’ from the user's IP address and the collected database.

The present invention can also benefit local government bodies by allowing city or county governments to send out public notices or announcement to only those users who are within the jurisdiction of the governments. Without this methodology, it is inconceivable for the County of Los Angeles to use the Internet to actively inform its residents that property taxes are now due. However, with the present invention, the County can target its announcement to its residents no matter which web sites the residents are browsing, as long as the web sites being browsed uses the methodology in accordance with the present invention. The County can certainly place the information at its own web site, but there is no guarantee that the residents will visit the local government's web site, which some local governments may not have the resources to fully develop their web sites. With this methodology, the information will be essentially “pushed” to the residents when the residents are visiting web sites equipped with the present invention.

8. Since the advertisement or messaging will be more geographically related to the users, the advertisement or messaging may contain a “Get Coupon”, “Get Map” or “Get Property Tax Form” button to allow the users to get a map of the merchant or a form from the county government or a coupon. Also, the advertisement can even contain a coupon to offer to the Internet client. Now, the Internet user is first reminded of how close a supermarket is to his present location, and then offered a coupon tcoupon tcoupon suill be a little difficult for the user to resist such an offering of convenience and value. Also, since the users access the coupons only when they are interested enough based on the geographically targeted advertisements they receive, the coupons are more effective than other mass mailing coupons.

The database can also be cross-referenced with other third party “life style” database to better target the users. For example, companies like Engage Technologies builds a global user database. However, such database may be deficient in geographically targeting advertisement to users. With the database of the present invention, more relevant advertisement can be generated.

The present invention can readily benefit e-commerce web sites such as Amazon.com, or Yahoo.com, since the customer's physical address is already known either through on-line purchase or by on-line registration, although some users never give out truthful information. Such user's information, when compared with the existing database, is filtered if it turns out to be inaccurate. However, the collection only gets better as more users' information are gathered and correlated.

Now, the merchant can use the present invention to generate a lookup table of its customers or users, corresponding the IP addresses to the physical addresses. The merchant can then generate geographically targeted advertisement to its customers and users, even if the user has given out false information about itself. It should be noted that the false information can be filtered out during the correlation stage. However, the user's IP address, when accessing the web, never lies. Therefore, with the database of correlations, an user will get a location-based advertisement, irrespective of his submitted false location information.

For example, a web site such as Amazon.com may want to get Ford Motor Company to sponsor advertisement where the local dealership advertisements are targeted to those visitors to web site who are from within the same area. The web site can also use its high-hit rate from Chicago visitors to attract a Chicago-based merchant, or city government, to advertise at the web site. As can be appreciated by those skilled in the art, the present invention empowers the local or regional merchants who are otherwise left out of the Internet advertisement industry.

In order to target Internet users by their geographic location, some or all of the following steps may be taken:

Deploy a very large number of geographically oriented applets.

From within these applets, or any other e-commerce application, ask the user for his/her street address or derive such address attributes from the user's area of interest.

Geocode the user's address and store the address, at/long coordinates and IP address within one or several database recorse recorse records.

Perform steps one and two, millions of times and build a database relating IP addresses with geographic location.

Resolve multiple entries for the same IP address by building an area polygon representing all the possible locations for that IP.

Use the client's IP and the above database to geographically locate a user at a later date.

When an exact match for the client's IP is not found, match to another IP that has the maximum number of significant bits in common (Match bits left to right).

Derive the most likely demographic of the user based on his/her geographic location. In order to do this it might be necessary to reference a geographic coverage file.

Target a banner ad by: zip code, city, state, radial distance, drive time, local time or a combination thereof.

Target a banner ad by: Demographic segment.

Cross reference, using the address field or lat/long, to third party “Life Style” data to target the user by life style.

Place a get directions button within the banner ad to show the user a way to the advertiser's location. Or a coupon button can be placed to give extra incentives to the users.

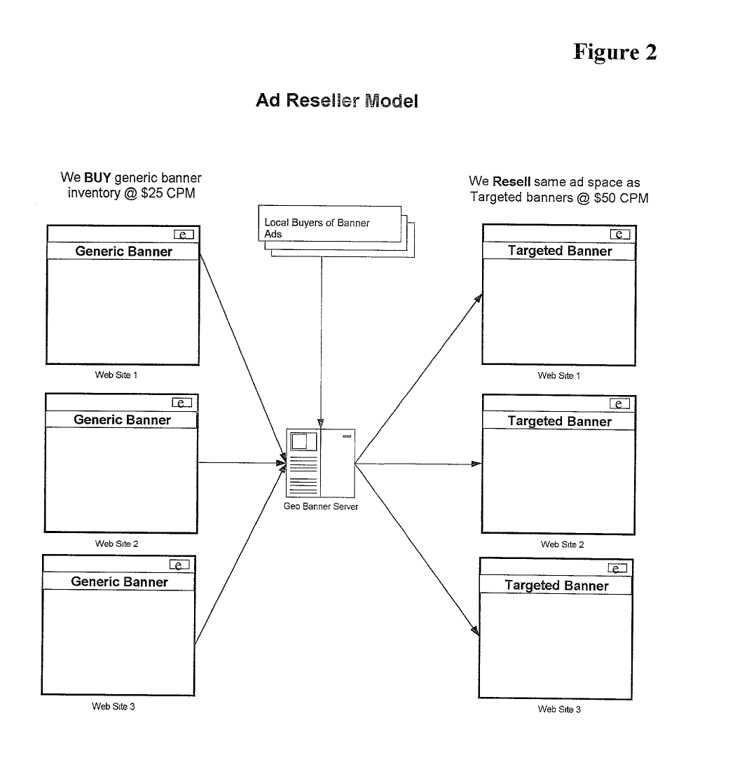

Reference is now made to FIG. 2, where an exemplary diagram showing the present invention is illustrated. Here the present invention provides a methodology to redistribute Internet advertisements based on geography. An owner of a geographic targeting service, it can also act as a value-added reseller for any Internet ad banner. Because conventional Internet banners are not very targeted, their cost remains low (currently about $25 dollars per 1000 impressions). When targeted by geographic region, these ads can be resold at a much higher cost per thousand perhaps as much as $50). This type of banner rotation and targeting can be done in real time.

Physical Realization of the Present Invention

One aspect of the environment in which the present invention can be realized is a typical Internet client and server network. A client can access the web server using landlines or dedicated high-speed line, with the help of an ISP. This is essentially how the Internet and WWW operate today. The software can be implemented based on the description provided.

We claim:

1. A method of targeting an Internet messaged to an Internet client based on geographic information of the Internet client, comprising:
(a) obtaining IP addresses of Internet clients as they visit at least one web site;
(b) obtaining addresses from the Internet clients;
(c) transforming the addresses to latitude/longitude coordinates for each of the Internet clients;
(d) generating a lookup table by correlating the IP addresses with the addresses and latitude/longitude coordinates;
(e) mining information in the table to resolve multiple entry conflicts to extract most likely position of a particular address;
(f) obtaining an IP address from the Internet client to be targeted;
(g) approximating the location of the Internet client by comparing the client's IP address with the lookup table;
(h) transmitting a predetermined message to the Internet client, wherein the predetermined message is related to the geographical location of the Internet client.

2. The method according to claim 1, wherein the predetermined message is sponsored by a third party within a predetermined geographical distance from the Internet client's geographical location.

3. The method according to claim 1, further comprising:
(i) providing a secondary message to be offered to the Internet client when the Internet client responds to the predetermined message.

4. The method according to claim 3, wherein the secondary message invokes one of the following:
a coupon for money off from the third party;
a document offered by the third party;
an electronelectronelectronic mail to be sent to th′m(.0U

5. The method according to claim 1, wherein the step of obtaining geographical information from the Internet users is accomplished by deploying at least one geographically oriented applet which will collect the Internet clients' geographical information upon invoking the applets.

6. The method according to claim 1, wherein the lookup table correlates the following entries:
IP addresses;
physical addresses;
zip codes;
latitude and longitude coordinates;
Local time;
Confidence Level and
Map view extent.

7. The method according to claim 1, wherein a client's demographic is derived from his/her geographic location.

8. The method according to claim 1, wherein the client is identified by a unique string, in which case his/her geographic location can be immediately looked up.

9. A method of targeting at least one geographically based message to at least one Internet client of at least one web site server, comprising:
(a) providing a database correlating IP addresses with geographical information;
(b) acquiring at least one generic messaging space from at least one web site;
(c) obtaining an IP address of the Internet client when the Internet client visits the web site;
(d) determining the geographical location of the Internet client based on one of IP address and a stored cookie;
(e) transmitting a first message to the Internet client through the web site, wherein the first message is related to the geographic location of the Internet client.

10. The method according to claim 9, further comprising transmitting a secondary message to the Internet client after the Internet client responds to the first message, wherein the secondary message is one of the following:
a coupon, a document, or a map.

11. A method of using a computer to transmitting targeted information to an Internet client of a web server, comprising the steps:
a. collecting IP addresses from a plurality of Internet clients;
b. collecting geographical addresses from the plurality of Internet clients;
c. geocoding each of the collected geographical addresses to generate location information for each of the geographical attributes;
d. generating a look-up table substantially correlating the IP addresses to the location information;
e. collecting the IP address of the Internet client;
f. generating a location information for that Internet client based on the look-up table;
g. retrieving a target information relating to the location information;
h. transmitting the targeted information to the Internet client while the Internet client is accessing the web server.

12. The method according to claim 11, wherein the step of generating a location information is done by interpolation and approximation.

13. The method according to claim 11, wherein the step g) of retrieving a target information comprises:
a. auctioning the location information regarding that Internet client to at least one advertising sources;
b. upon receiving a successful bid from one source retrieving a targeting information from that source for transmission to the Internet client.
